(19) United States
(12) Patent Application Publication
(10) Pub. No.: US 2023/0265366 A1
(43) Pub. Date: Aug. 24, 2023

(54) EDIBLE ALCOHOL-CONTAINING SPHERES

(71) Applicant: CDJ Partners, LLC, Sicklerville, NJ (US)

(72) Inventors: Justin Peckerofsky, Sicklerville, NJ (US); Jack Parker, Sparta, NJ (US)

(73) Assignee: CDJ Partners, LLC, Sicklerville, NJ (US)

(21) Appl. No.: 18/141,145

(22) Filed: Apr. 28, 2023

Related U.S. Application Data
(63) Continuation of application No. 16/568,728, filed on Sep. 12, 2019, now abandoned.
(60) Provisional application No. 62/855,115, filed on May 31, 2019.
(60) Provisional application No. 62/730,212, filed on Sep. 12, 2018.

(51) Int. Cl. C12G 3/005; A23L 29/269; A23P 20/10; A23L 27/30; A23L 29/262; A23P 10/30; A23P 30/10; A23L 29/00; A23L 27/12; C12G 3/06

(52) U.S. Cl. CPC C12G 3/005; A23L 27/13; A23L 27/33; A23L 29/03; A23L 29/262; A23L 29/27; A23P 10/30; A23P 20/105; A23P 30/10; C12G 3/06

(57) ABSTRACT

A shelf stable, edible sphere containing alcohol and methods for preparing the same. The edible sphere comprises a liquid and/or gel inner core comprising ethyl alcohol and an outer membrane comprising alginate, wherein the outer membrane coats and encapsulates the liquid and/or gel inner core and wherein the edible sphere is shelf stable for at least one month. The process for preparing the shelf stable, edible sphere comprises combining an alcoholic beverage, a calcium salt, and optionally one or more further components to form a cocktail solution, deaerating and either freezing the cocktail solution to form a frozen cocktail solution or adding a thickening compound to the de-aerated cocktail solution to form a viscous cocktail solution, immersing the frozen cocktail solution or viscous cocktail solution in a sodium alginate bath at ambient temperature for a period of time to form an edible sphere containing alcohol, and removing the edible sphere containing alcohol from the alginate bath and rinsing it with water to form a shelf stable edible sphere.

### CROSS-REFERENCE TO RELATED APPLICATIONS

Pursuant to 35 U.S.C. §120, this U.S. Non-Provisional Pat. application, filed pursuant to 35 U.S.C. §111(a), is a continuation of and claims the benefit of U.S. Pat. application Serial No. 16/568,728, filed Sep. 12, 2019, and, pursuant to 35 U.S.C. §119(e), claims the benefit of U.S. Provisional Pat. application Serial No. 62/730,212, filed Sep. 12, 2018, and U.S. Provisional Pat. application Serial No. 62/855,115, filed May 31, 2019, all of which are incorporated herein by reference in their entireties.

### FIELD OF THE INVENTION

The present disclosure relates generally to edible, ethyl alcohol-containing spheres having an extended shelf life, as well as to methods of preparing such edible spheres.

### BACKGROUND OF THE INVENTION

Distilled spirits, such as vodka, whiskey/whisky, etc., are commercially available in small bottles or other containers made of glass, plastic, or the like. However, such containers are obviously not edible or readily dissolvable when contacted with a liquid, such as an aqueous beverage.

Consumable items colloquially known as “Jell-O Shots,” which are produced by mixing a gelatin-based desert composition with a shot (approximately 1-2 ounces) of an alcoholic beverage (typically vodka or another distilled spirit) and then allowed to cool and gel, are known. However, such alcoholic compositions are subject to “melting” or liquefaction if stored at ambient or slightly above ambient temperatures.

Other consumable items colloquially known as “cocktail caviar,” which are small, pearl-or tapioca-sized spheres produced from alcoholic beverages, such as champagne, using reverse spherification processes typically performed in a restaurant or bar setting, are also known. However, these novelty cocktails are not storage stable. For example, the calcium used to prepare these spheres tends to precipitate out in their liquid interior over time in the form of insoluble calcium salts, forming a white layer at the bottom of the sphere. Such precipitates can negatively impact the flavor, mouth feel, and general enjoyment of the sphere by its consumer. As such, these sphere are intended to, and must, be consumed immediately on-site. Moreover, because of the small size of each individual sphere, a large number must be consumed in order to experience the physiological effects for which alcohol is generally consumed.

Accordingly, there remains a continuing need for an alcoholic composition having an extended shelf life for recreational ingestion of alcohol, wherein a sufficient quantity of alcohol is held within an edible and/or aqueous soluble encapsulating membrane to permit one or a plurality of thereof to be eaten or dissolved so as to provide the physiological effects for which alcohol is generally consumed.

### EMBODIMENTS OF THE INVENTION

An embodiment of the present invention is a shelf stable, edible sphere comprising (1) a liquid and/or gel inner core comprising ethyl alcohol and (2) an outer membrane comprising alginate, wherein the outer membrane coats and encapsulates the liquid and/or gel inner core and wherein the shelf stable, edible sphere is shelf stable for at least one month. In certain embodiments, the shelf stable, edible sphere is shelf stable for at least 12 months. In certain embodiments, the volume of the liquid and/or gel inner core is at least 25 mL. In certain embodiments, the liquid and/or gel inner core has an ABV of greater than 9%.

Another embodiment of the present invention is the above shelf stable, edible sphere, wherein the ethyl alcohol is derived from an alcoholic beverage. In certain embodiments, the alcoholic beverage is derived from a distilled spirit and/or a liqueur. In certain embodiments, the distilled spirit is selected from the group consisting of grain alcohol, vodka, gin, rum, tequila, whiskey/whisky, brandy, cachaça, metaxa, mezcal, ouzo, absinthe, and any combination thereof.

Another embodiment of the present invention is the above shelf stable, edible sphere, wherein the outer membrane further comprises an edible coating and encapsulating material in addition to the alginate. Another embodiment of the present invention is the above shelf stable, edible sphere, wherein the outer membrane further comprises one or more components selected from the group consisting of sweeteners, stabilizers, preservatives, flavorants, colorants, and any combination thereof. Another embodiment of the present invention is the above shelf stable, edible sphere, wherein the thickness of the outer membrane is in the range of from 0.01 mm to 0.5 mm.

Another embodiment of the present invention is the above shelf stable, edible sphere, wherein the liquid and/or gel inner core comprises one or more components selected from the group consisting of water, an organic acid, a calcium salt, a fruit juice, a fruit juice concentrate, a sweetener, a stabilizer, a preservative, a thickener, an anti-foaming agent, a natural flavorant, an artificial flavorant, a colorant, and any combination thereof. In certain embodiments, the organic acid is selected from the group consisting of ascorbic acid, malic acid, and any combination thereof. In certain embodiments, the calcium salt is selected from the group consisting of calcium lactate, calcium lactate gluconate, and any combination thereof. In certain embodiments, the stabilizer and/or the thickener is selected from the group consisting of xanthan-based gums, cellulose-based gums, and any combination thereof. In certain embodiments, the fruit juice and/or fruit juice concentrate is selected from the group consisting of lemon juice, clarified cranberry juice concentrate, clarified pineapple juice concentrate, and any combination thereof. In certain embodiments, the natural flavorant and/or the artificial flavorant is selected from the group consisting of lemon flavorants, lime flavorants, cranberry flavorants, lime flavorants, orange flavorants, pineapple flavorants, apple flavorants, sour apple flavorants, peach flavorants, and any combination thereof. In certain embodiments, the sweetener is sucrose. In certain embodiments, the shelf stable, edible sphere does not comprise a preservative. In certain embodiments, the shelf stable, edible sphere does not comprise sodium benzoate, potassium sorbate, or combinations thereof.

Yet another embodiment of the present invention is a process for preparing a shelf stable, edible sphere, comprising (1) combining an alcoholic beverage, a calcium salt, and optionally one or more further components selected from the group consisting of a stabilizer, a thickener, an anti-foaming agent, an organic acid, a sweetener, a fruit juice, a fruit juice concentrate, water, a natural flavorant, an artificial flavorant, a colorant, a preservative, and any combination thereof, to form a cocktail solution, (2) de-aerating the cocktail solution to form a de-aerated cocktail solution, (3) freezing the de-aerated cocktail solution to form a frozen cocktail solution or adding a thickening compound to the de-aerated cocktail solution to form a viscous cocktail solution, (4) immersing the frozen or viscous cocktail solution in a sodium alginate bath at ambient temperature or at a controlled temperature above or below ambient temperature for a period of time to form an edible sphere, and (5) removing the edible sphere from the alginate bath and rinsing the edible sphere with water to form a shelf stable, edible sphere.

Another embodiment of the present invention is the above process, wherein the stabilizers, thickeners, and/or anti-foaming agents are hydrated prior to combination with the alcoholic beverage and the calcium salt.

Another embodiment of the present invention is the above process, wherein the de-aerated cocktail solution is frozen in a semi-spherical mold.

Another embodiment of the present invention is the above process, wherein the de-aerated cocktail solution is frozen at a temperature of -10° F. or lower.

Another embodiment of the present invention is the above process, wherein the sodium alginate bath was prepared by dissolving sodium alginate powder in distilled water in a ratio by weight of 0.5 % sodium alginate to 99.5 % distilled water.

Another embodiment of the present invention is the above process, the frozen cocktail solution is immersed in the sodium alginate bath at ambient temperature for at least 10 minutes.

### BRIEF DESCRIPTION OF THE FIGURES

The foregoing, as well as the following detailed description of the invention, will be better understood when read in conjunction with the appended figures. It should be understood, however, that the present invention is not limited to the precise arrangements and instrumentalities shown.

FIG. 1 depicts a shelf stable edible sphere according to an embodiment of the present invention.

FIG. 2 depicts a plurality of shelf stable edible sphere according to an embodiment of the present invention.

FIG. 3 depicts the formation of edible spheres in a sodium alginate bath in accordance with an embodiment of the process of the present invention

FIG. 4 depicts rinsing of edible spheres in distilled water in accordance with an embodiment of the process of the present invention.

FIG. 5 depicts plumping of shelf stable edible spheres according to an embodiment of the present invention via osmosis.

### DETAILED DESCRIPTION OF THE INVENTION

One aspect of the present invention is directed to shelf stable, edible spheres containing alcohol (i.e., ethyl alcohol-containing spheres having an extended shelf life).

As used herein, the terms “shelf stable” and “extended shelf life” are defined as the ability of edible items, such as food and drink, which are otherwise perishable within a matter of a few hours or days, to be safely stored at ambient temperature (i.e., without refrigeration) for weeks, months, or years.

As used herein, the term “edible” is defined as capable of being eaten by a human subject (i.e., digestible and fit for human consumption).

As used herein, the term “sphere” is defined to not only include perfectly round, three-dimensional objects (i.e., an object where every point on its surface is equidistant from its geometric center), but also imperfectly round, three-dimensional objects, such as spheroids and ellipsoids.

As used herein, the term “alcohol” is defined as ethyl alcohol (or ethanol) and does not encompass other chemically distinct alcohols, such as methyl alcohol or methanol (i.e., wood alcohol) and isopropyl alcohol or isopropanol (i.e., rubbing alcohol).

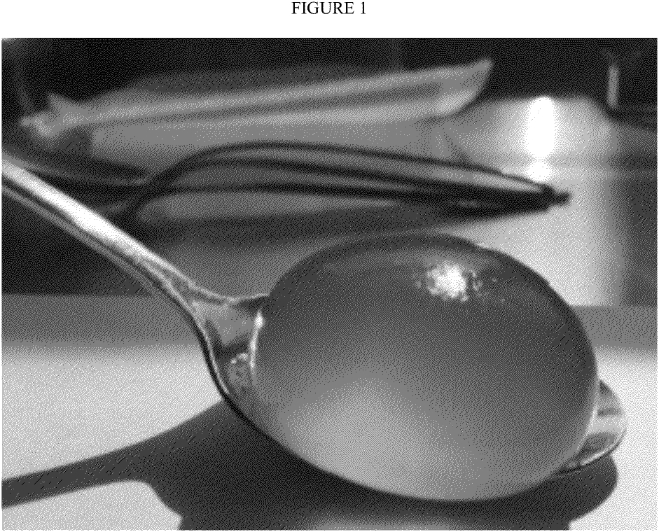

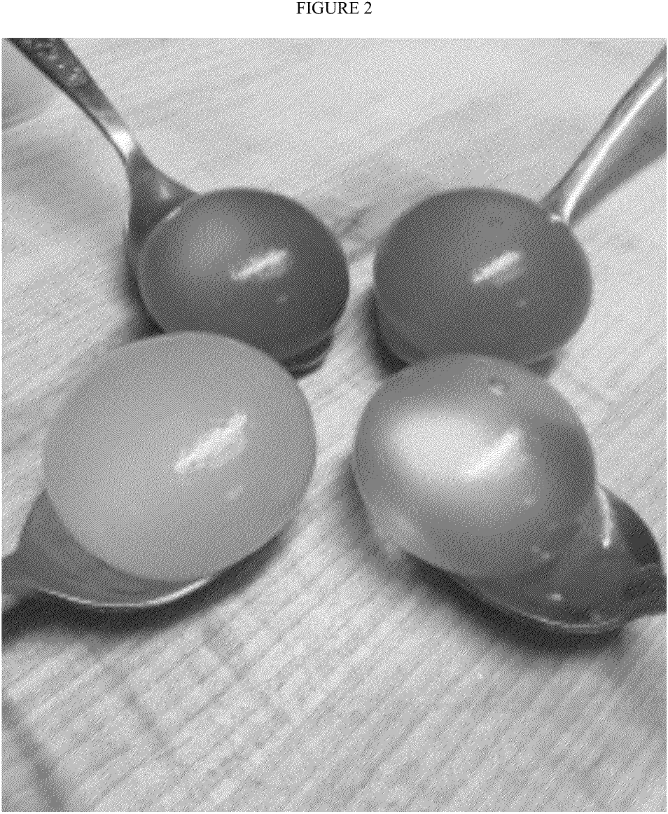

The shelf stable, edible spheres according to the present invention comprise a liquid and/or gel inner core comprising ethyl alcohol and an outer membrane comprising alginate, wherein the outer membrane coats and encapsulates the liquid and/or gel inner core and wherein the edible sphere is shelf stable for at least one month. See FIGS. 1 and 2.

The source of the ethyl alcohol in the inner core of the shelf stable edible spheres according to the present invention can be pure ethyl alcohol (otherwise known as pure ethanol, or absolute alcohol), or can be from any known alcoholic beverage(s) (i.e., a beverage that contains ethyl alcohol in addition to other components, including water), or any combination thereof. In certain embodiments, the source of the ethyl alcohol is pure ethyl alcohol. In certain other embodiments, the source of the ethyl alcohol is one or more alcoholic beverages.

Examples of such alcoholic beverages include, but are not limited to, any type of distilled spirits, liqueurs, wines, beers, or any combination thereof.

Examples of distilled spirits that can be a source of the ethyl alcohol in the inner core of the shelf stable, edible spheres according to the present invention include, but are not limited to, grain alcohol (otherwise known as rectified spirits or neutral spirits), vodka, gin, rum, tequila, whiskies, such as Bourbon, Rye, Irish, Scotch, and Canadian whiskies, brandies, such as Armagnac and cognac, cachaça, metaxa, mezcal, ouzo, and absinthe.

Examples of liqueurs that can be a source of the ethyl alcohol in the inner core of the shelf stable, edible spheres according to the present invention include, but are not limited to, Chambord®, Kahlúa®, Tia Maria®, Amarula®, Baileys Irish Cream®, crème de banane, crème de cacao, St-Germain®, Curaçao®, Grand Marnier®, Hpnotiq®, limoncello, Midori®, Pucker®, sloe gin, triple sec, Ricard®, sambuca, crème de menthe, Goldschläger®, Jägermeister®, Metaxa®, Drambuie®, Irish Mist®, Yukon Jack®, Amaretto®, Disaronno®, Frangelico®, Drambuie®, Fireball Cinnamon Whisky®, Irish Mist®, Southern Comfort®, Rumpleminze®, and Tuaca®.

Furthermore, any suitable alcoholic cocktail may be a source of the ethyl alcohol in the inner core of the shelf stable, edible spheres according to the present invention. Examples of such suitable alcoholic cocktails include, but are not limited to, those disclosed in Death & Co: Modern Classic Cocktails by David Kaplan, et al. (published by Ten Speed Press, Oct. 7, 2014), Meehan’s Bartender Manual by Jim Meehan (published by Ten Speed Press, Oct. 17, 2017), The Savoy Cocktail Book by Harry Craddock (published by Martino Fine Books, Jul. 3, 2015), The Professional Bartender’s Handbook by Valerie Mellema (published by Atlantic Publishing Group Inc., Nov. 30, 2007), and The Ultimate Bar Book: The Comprehensive Guide to Over 1,000 Cocktails by Mittie Hellmich (published by Chronicle Books, Jun. 23, 2006), each of which is incorporated herein in its entirety. In certain embodiments, the source of the ethyl alcohol in the inner core of the shelf stable, edible spheres according to the present invention is a cocktail containing vodka. In certain other embodiments, the source of the ethyl alcohol in the inner core of the shelf stable, edible spheres according to the present invention is a cocktail containing triple sec. In yet certain other embodiments, the source of the ethyl alcohol in the inner core of the shelf stable, edible spheres according to the present invention is a cocktail containing a combination of vodka and triple sec.

The inner core of the shelf stable, edible spheres according to the present invention can further comprise one or more components in addition to ethyl alcohol. These components can be in the form of any suitable edible liquid, puree, or solid in the form of small pieces (e.g., fibers, particles, etc.). Examples of such components include, but are not limited to, water, organic acids, calcium salts, fruit juices and fruit juice concentrates, vegetable juices, cow milk, soy milk, sweeteners, stabilizers, preservatives, thickeners, anti-foaming agents, natural and artificial flavorants, and colorants.

Any suitable type of potable water can be added as a component to the shelf stable, edible spheres according to the present invention. Examples of such types of water include, but are not limited to, tap water, spring water, distilled water, deionized water, carbonated water, filtered water (e.g., by reverse osmosis and/or carbon filtration), or any combination thereof.

Any suitable food grade organic acid can be added as a component to the shelf stable, edible spheres according to the present invention. Examples of such organic acids include, but are not limited to, ascorbic acid, malic acid, malonic acid, acetic acid, citric acid, lactic acid, folic acid, gluconic acid, fumaric acid, tartaric acid, propionic acid, or any combination thereof.

Any suitable food grade calcium salt can be added as a component to the shelf stable, edible spheres according to the present invention. Examples of such calcium salts include, but are not limited to, calcium lactate, calcium lactate gluconate, or any combination thereof.

Any suitable juice can be added as a component to the shelf stable edible spheres according to the present invention. Examples of such juices include, but are not limited to, fruit juices and fruit juice concentrates, vegetable juices, clam juice, or any combination thereof. Examples of fruit juices and fruit juice concentrates include, but are not limited to, lemon juice, clarified cranberry juice concentrate, clarified pineapple juice concentrate, or any combination thereof.

Any suitable food grade sweetener, both naturally occurring and artificial, can be added as a component to the shelf stable, edible spheres according to the present invention. Examples of such sweeteners include, but are not limited to sucrose, lactose, maltose, glucose, fructose, galactose, corn syrup, high-fructose corn syrup, honey, molasses, agave nectar, stevia, glycerin, mogrosides, acesulfame potassium, aspartame, cyclamate, saccharin, sucralose, sugar alcohols, such as sorbitol, xylitol, erythritol, and lactitol, or any combination thereof. In certain embodiments, sucrose (“sugar”) is used as the sweetener in the form of simple syrup (i.e., white sugar dissolved in water in a 1:1 by volume ratio). Furthermore, sugar can be used in any commercially available form, examples of which include, but are not limited to, granulated, caster, confectioners, pearl, sanding, cane, demerara, turbinado, muscovado, light brown, dark brown, liquid, or any combination thereof.

Any suitable food grade stabilizers and thickeners can be added as a component to the shelf stable edible spheres according to the present invention. Examples of such stabilizers and thickeners include, but are not limited to food grade gums (i.e., hydrocolloids) and starches. Examples of such gums include, but are not limited to, xanthan-based gums (e.g., Ticaxan Xanthan 200®), cellulose-based gums (e.g., Ticalose CMC 2500), acacia-based gums, locust bean-based gums, gellan-based gums, or any combination thereof.

Any suitable food grade preservatives can be added as a component to the shelf stable, edible spheres according to the present invention. Examples of such preservatives include, but are not limited to, the aforementioned organic acids, benzoic acid, benzoates, such as sodium benzoate and potassium benzoate, propionic acid, propionates, such as sodium propionate potassium propionate, sorbic acid, sorbates, such as sodium sorbate and potassium sorbate, ascorbates, such as sodium ascorbate and potassium ascorbate, parabens, sulfur dioxide, sulfites, nitrites, nitrates, butylated hydroxytoluene (BHT), butylated hydroxyanisole (BHA), tocopherols, such as vitamin E, vitamin C, disodium ethylenediaminetetraacetic acid (EDTA), polyphosphates, hops, fermentates, Nisin, or any combination thereof. In certain embodiments, the shelf stable, edible spheres according to the present invention do not comprise a preservative. In certain embodiments, the shelf stable, edible spheres according to the present invention do not comprise sodium benzoate, potassium sorbate, or combinations thereof. Any suitable food grade, natural or synthetic anti-foaming agent (e.g., Magrabar MD-3000®), or any combination thereof, can be added as a component to the shelf stable edible spheres according to the present invention.

Any suitable food grade flavorant can be added as a component to the shelf stable, edible spheres according to the present invention. Such flavorants can be natural or artificial and sweet or savory, and includes, but is not limited to, fruit flavorants, vegetable flavorants, meat flavorants, poultry flavorants, fish flavorants, or any combination thereof. Examples of such natural and artificial fruit flavorants include, but are not limited to, lemon flavorants, lime flavorants, cranberry flavorants, orange flavorants, pineapple flavorants, apple flavorants, sour apple flavorants, peach flavorants, or any combination thereof.

Any suitable food grade colorants can be added as a component to the shelf stable, edible spheres according to the present invention. Such colorants can be natural, artificial, or any combination thereof. Examples of synthetic colorants include, but are not limited to, FD&C colorants, such as FD&C Blue #1 and FD&C Yellow #5. Examples of natural colorants include, but are not limited to, fruit extracts, vegetable extracts, or any combination thereof.

The inner core can be liquid or gel or a combination of both. In certain embodiments, the inner core will comprise substantially of a combination of water and alcohol, which are both liquid at ambient temperature. In such embodiments, whether the inner core is ultimately partially or completely a gel will depend on the nature and concentration of any additional components present. For example, if, in certain embodiments, xanthan- and/or cellulose-based gums are employed in the inner core as stabilizers and/or thickeners (and which may require hydration to form a gel prior to use), the resulting core may be partially or completely gel-like in consistency, depending on the nature and concentration of the xanthan- and/or cellulose-based gums employed.

The liquid and/or gel inner core can have any suitable volume. In certain embodiments, the liquid and/or gel inner core has a volume in the range of from about 0.1 mL to about 90 mL. In certain embodiments, the volume of the liquid and/or gel inner core is approximately 0.1 mL, 0.2 mL, 0.3 mL, 0.4 mL, 0.5 mL, 0.6 mL, 0.7 mL, 0.8 mL, 0.9 mL, or 1.0 mL. In certain embodiments, the volume of the liquid and/or gel inner core is at least 25 mL. In certain other embodiments, the volume of the liquid and/or gel inner core is approximately 30 ml, 45 mL, 60 mL, 75 mL, or 90 mL. In certain embodiments, the liquid and/or gel inner core has a volume in the range of from about 0.003 fluid ounces to about 3 fluid ounces. In certain embodiments, the volume of the liquid and/or gel inner core is approximately 0.003 fluid ounces, 0.007 fluid ounces, 0.010 fluid ounces, 0.013 fluid ounces, 0.017 fluid ounces, 0.020 fluid ounces, 0.024 fluid ounces, 0.027 fluid ounces, 0.030 fluid ounces, or 0.034 fluid ounces. In certain embodiments, the volume of the liquid and/or gel inner core is at least 0.85 fluid ounces. In certain other embodiments, the volume of the liquid and/or gel inner core is approximately 1.0 fluid ounce, 1.5 fluid ounces, 2.0 fluid ounces, 2.5 fluid ounces, or 3.0 fluid ounces.

The liquid and/or gel inner core can be of any suitable alcohol-by-volume (ABV). In certain embodiments, the liquid and/or gel inner core can have an ABV of up to 50%. In certain embodiments, the liquid and/or gel inner core can have an ABV in the range of from 0.01% to 40%. In certain embodiments, the liquid and/or gel inner core can have an ABV of 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38, 39%, or 40%. In certain embodiments, the liquid and/or gel inner core can have an ABV of 9% or less. In certain embodiments, the liquid and/or gel inner core can have an ABV of greater than 9% or less.

The outer membrane comprising alginate completely coats and encapsulates the liquid and/or gel inner core. The outer membrane may also comprise further edible coating and encapsulating materials in addition to the alginate. Examples of such further edible coating and encapsulating materials include, but are not limited to, gelatin, xanthan gum, guar gum, chitin, chitosin, gellan gum, agar, carrageenan, albumin, starch, and carboxymethylcellulose. And like the inner core, the outer membrane can further comprise one or more additional components. Examples of such components include, but are not limited to sweeteners, stabilizers, preservatives, flavorants, and colorants, as described herein.

The outer membrane can be of any suitable thickness. In certain embodiments, the thickness of the outer membrane is in the range of from 0.01 mm to 0.50 mm. In certain other embodiments, the thickness of the outer membrane is in the range of from 0.05 mm to 0.40 mm. In certain other embodiments, the thickness of the outer membrane is in the range of from 0.10 mm to 0.30 mm. In certain embodiments, the thickness of the outer membrane is 0.01 mm, 0.02 mm, 0.03 mm, 0.04 mm, 0.05 mm, 0.06 mm, 0.07 mm, 0.08 mm, 0.09 mm, 0.10 mm, 0.11 mm, 0.12 mm, 0.13 mm, 0.14 mm, 0.15 mm, 0.16 mm, 0.17 mm, 0.18 mm, 0.19 mm, 0.20 mm, 0.21 mm, 0.22 mm, 0.23 mm, 0.24 mm, 0.25 mm, 0.26 mm, 0.27 mm, 0.28 mm, 0.29 mm, 0.30 mm, 0.31 mm, 0.32 mm, 0.33 mm, 0.34 mm, 0.35 mm, 0.36 mm, 0.37 mm, 0.38 mm, 0.39 mm, 0.40 mm, 0.41 mm, 0.42 mm, 0.43 mm, 0.44 mm, 0.45 mm, 0.46 mm, 0.47 mm, 0.48 mm, 0.49 mm, or 0.50 mm.

The edible spheres according to the present invention are shelf stable (i.e., they can be safely stored at ambient temperature (i.e., without refrigeration) for weeks, months, or years). In certain embodiments, edible spheres according to the present invention are shelf stable for at least one (1) month. In certain other embodiments, edible spheres according to the present invention are shelf stable for at least three (3) months. In yet certain other embodiments, edible spheres according to the present invention are shelf stable for at least six (6) months. In yet certain other embodiments, edible spheres according to the present invention are shelf stable for at least one year (i.e., 12 months). In yet certain other embodiments, edible spheres according to the present invention are shelf stable for at least 18 months. In yet certain other embodiments, edible spheres according to the present invention are shelf stable for at least two years (i.e., 24 months).

Another aspect of the present invention is directed to processes for preparing shelf stable, edible spheres containing alcohol.

The shelf stable, edible spheres according to the present invention can be prepared by any suitable method known in the art. In certain embodiments, these shelf stable edible spheres can be prepared by a modified reverse spherification process according to the present invention. This process comprises (1) combining an alcoholic beverage, a calcium salt, and optionally one or more further components selected from the group consisting of a stabilizer, a thickener, an anti-foaming agent, an organic acid, a sweetener, a fruit juice, a fruit juice concentrate, water, a flavorant, a colorant, a preservative, and any combination thereof, to form a cocktail solution, (2) de-aerating the cocktail solution to form a de-aerated cocktail solution, (3) freezing the de-aerated cocktail solution to form a frozen cocktail solution or adding a thickening compound to the de-aerated cocktail solution to form a viscous cocktail solution, (4) immersing the frozen or viscous cocktail solution in a sodium alginate bath at ambient temperature or at a controlled temperature above or below ambient temperature for a period of time to form an edible sphere, (5) and removing the edible sphere from the alginate bath and rinsing the edible sphere with water to form a shelf stable, edible sphere.

In certain embodiments, the stabilizers, thickeners, and/or anti-foaming agents are hydrated to form a gel prior to combination with the alcoholic beverage, calcium salt, and any other components that will ultimately form the liquid and/or gel inner core of the shelf stable, edible spheres according to the present invention. The hydrated gel of stabilizers, thickeners, and/or anti-foaming agents can then be added to all of the other (previously mixed) ingredients and mixed until fully incorporated. In certain embodiments, this can be achieved using any suitable commercial blender or high shear mixer or liquefier or similar.

In certain embodiments, once the stabilizers, thickeners, and/or anti-foaming agents are fully incorporated, the resulting cocktail solution may comprise trapped air bubbles. Since the presence of air bubbles in the shelf stable, edible spheres according to the present invention may result in structural weaknesses, thus making the edible spheres more susceptible to breakage, the cocktail solution can be de-aerated, i.e., the bubbles can be removed, such as, for example, in vacuo by placing the mixture into any suitable vacuum chamber or apparatus to suck all of the trapped air bubbles out of the thickened cocktail solution.

The de-aerated cocktail solution can be frozen using any suitably shaped mold made of any suitable material. In certain embodiments, the de-aerated cocktail solution is frozen in a semi-spherical mold. In certain embodiments, the de-aerated cocktail solution is frozen in a silicon mold.

Any suitable temperature may be used to freeze the de-aerated cocktail solution to form a frozen cocktail solution. In certain embodiments, the de-aerated cocktail solution is frozen at a temperature of -10° F. or lower. In certain embodiments, a temperature of -10° F. or lower may be necessary to achieve ice crystal formation in de-aerated cocktail solutions depending on the amount of alcohol and, if present, sugars dissolved therein. It should be noted that, in some embodiments, these frozen cocktail solutions do not freeze solid, but rather achieve the consistency of gelato.

Any suitable thickening compound can be added to the de-aerated cocktail solution to form a viscous cocktail solution. Examples of such thickening compounds include, but are not limited to, gums, starches, hydrocolloids, or any combination thereof, such as those described herein.

A sodium alginate bath having any suitable concentration of sodium alginate may be used in the process according to the present invention. In certain embodiments, the sodium alginate bath can be prepared by dissolving sodium alginate powder in distilled water in a ratio by weight of 0.5% sodium alginate to 99.5% distilled water at ambient temperature. See FIG. 8. Since sodium alginate does not dissolve easily in water, mechanical means, such as an emulsion blender, can be employed to mix small amounts of sodium alginate powder into the water. To remove air bubbles dispersed therein, the sodium alginate solution can, in certain embodiments, be rested overnight or until all of the bubbles have dispersed and the solution is clear, or, in other embodiments, it can be de-aerated in the same manner as the cocktail solution.

The frozen cocktail solution can be immersed in the sodium alginate bath at ambient temperature or at any suitable controlled temperature above or below ambient temperature for any suitable amount of time to form an outer membrane comprising alginate that completely coats and encapsulates the liquid and/or gel inner core. In certain embodiments, the frozen cocktail solution can be immersed in the sodium alginate bath at ambient temperature for anywhere from a few seconds to at least 10 minutes, depending on the desired thickness of the outer membrane. It should be noted that the only parameter that affects the thickness of the outer membrane comprising alginate is the amount of time the frozen cocktail solution / liquid and/or gel inner core spends in the sodium alginate bath. It should also be noted that the sodium alginate bath only needs to be few inches deep (e.g., 2 to 3 inches) to fully immerse a frozen cocktail solution having a volume of from 25 mL to approximately 90 mL. In certain embodiments, the sodium alginate bath is prepared in any suitable vessel of any size capable of holding a liquid (e.g., a long, deep rectangular container).

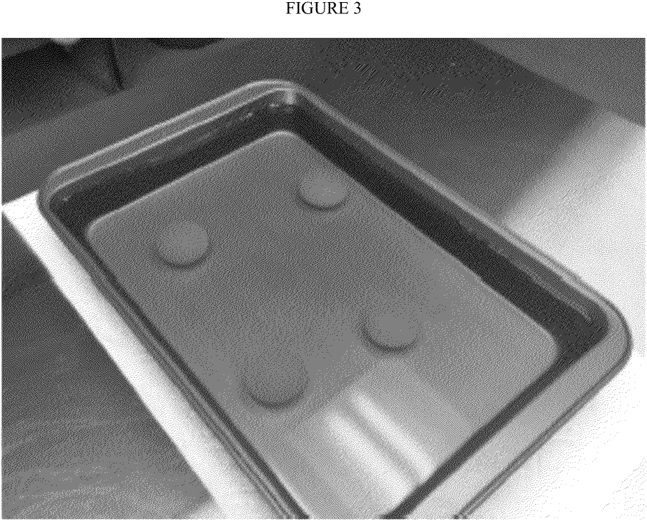

Prior to introducing the frozen cocktail solution into the sodium alginate bath, the back of the frozen mold can be gently dipped into warm water for a few seconds, which facilitates quick removal of the frozen cocktail solution from the mold. Alternatively, the frozen cocktail solution can simply be popped or dumped out of the mold. In certain embodiments, once the frozen cocktail solution(s) / liquid and/or gel inner core(s) are immersed in the alginate bath, the alginate bath can be gently agitated for the first 30 seconds of immersion to prevent them from touching each other or the sides and/or bottoms of the container while the outer membrane is forming to mitigate structural deformation of the resulting shelf stable, edible sphere or rupture of the outer membrane comprising alginate. After this initial 30 seconds, the shelf stable, edible spheres can contact each other in the alginate bath a low risk of damage. However, the shelf stable, edible spheres should nonetheless continue to be gently swirled and flipped for the remainder of their time in the alginate bath to facilitate formation of a round sphere. See FIG. 3.

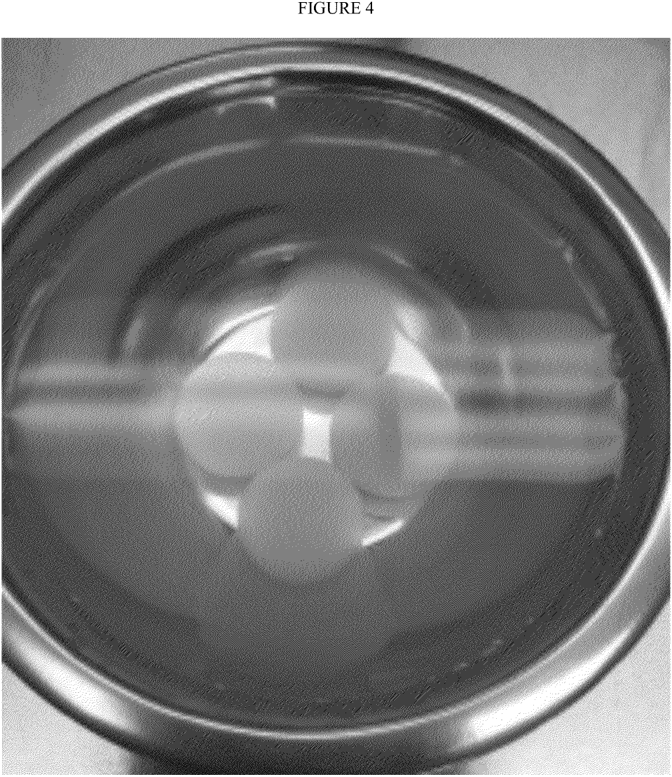

Removal of the shelf stable, edible sphere from the alginate bath and rinsing it with water, such as distilled water, for a period of time stops any further thickening of the outer membrane comprising alginate and also washes away any sodium ions on the outside of the edible sphere. In certain embodiments, the shelf stable, edible spheres are rinsed in distilled water for 30 seconds after removal from the alginate bath. See FIG. 4.

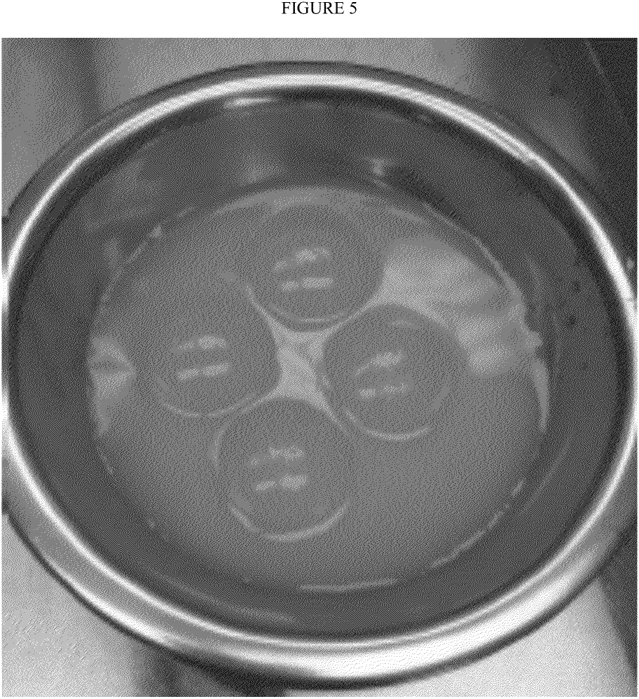

In certain embodiments, the shelf stable, edible sphere can then be placed into a container filled with a storing solution, i.e., the same liquid and/or gel that makes up its inner core minus the calcium salt, to facilitate osmosis, making the spheres plump without losing any flavor. See FIG. 5. In certain embodiments, the shelf stable, edible sphere can then be consumed immediately after preparation. In certain other embodiments, the shelf stable, edible spheres can then packed for storage and/or transport. In certain embodiments, the shelf stable, edible spheres can be packed into any suitable container, such as a jar or a poly cup (e.g., a K cup) with a peelable lid, which is then completely filled with storing solution, i.e., the same liquid and/or gel that makes up the inner core of the edible spheres minus the calcium salt, and then sealed. In certain other embodiments, the shelf stable, edible spheres can be packed and sealed into large containers in this same manner, which are then sold to bars and other vendors, who can, in turn, sell the shelf stable, edible spheres on an individual basis in shot glasses. In yet certain other embodiments, the shelf stable, edible spheres could be individually wrapped/packed in this same manner and then sold directly to consumers for consumption at home.

In certain embodiments, the shelf stable, edible spheres according to the present invention can be prepared according to the process of the present invention on a commercial scale via batch-wise production. In such batch-wise production, liquids and powders can be blended in tanks using a propeller type mixer or similar device. Both the alginate bath and de-aerated cocktail solution can be mixed in this manner. Silicone molds can be charged with de-aerated cocktail solution by hand or by using a dosing pump or small liquid product filler and then placed into a freezer. Any suitable conventional freezing equipment, such as blast freezers or cryogenic liquid freezers, can be used. The frozen cocktail solution can then be de-molded and dropped into the alginate bath. The alginate bath can be a tank, tray, pail, or drum fabricated from any food grade material that can hold liquid. Once the shelf stable, edible spheres are formed, they can be removed with a slotted spoon, screen, or by hand, and then placed into a water bath to stop outer membrane formation. The shelf stable, edible spheres can then be removed from the water bath, again by slotted spoon, screen, or hand, and placed into a finished product container. Additional de-aerated cocktail solution without calcium salt (i.e., storing solution) can then be added to the container, which is then sealed and labeled.

In certain embodiments, the shelf stable, edible spheres according to the present invention can be prepared according to the process of the present invention on a commercial scale via continuous production. In such continuous production, liquids and powders can be blended in large tanks using a propeller type mixer or similar device. Other mixing equipment can be used, such as high-shear, liquefier type-mixers, such as a Breddo Likwifier, or a system that blends powders and liquids in a continuous stream, such as a Silverson Flashmix. The de-aerated cocktail solution can then be deposited into hemispherical molds using an automated depositor, such as those manufactured by Universal, Unifiller, and Paxiom. The charged molds can then be conveyed to a continuous blast freezer, which can be conventional mechanical freezer or a liquid carbon dioxide (CO₂) or nitrogen (LN₂) freezer, respectively. After exiting the freezer, the molds can then be mechanically inverted and the frozen semi-spheres dropped into an alginate developer tank or sluice system. A sluice allows for continuous movement of the forming spheres with the advantage of allowing large quantities of shelf stable, edible spheres to be continuously produced. Sluices are widely used in the fruit and vegetable processing business and can be comprised of premade modular units or constructed by a fabricator. The shelf stable, edible spheres can then be removed from the sluice with an inclined conveyor with de-watering holes or slots and dropped into a water bath or rinse system. This can take the form of another sluice, water sprays, or a tank system. The shelf stable, edible spheres can then be removed from the wash with an inclined conveyor with de-watering holes or slots and conveyed to a product filling station. The shelf stable, edible spheres can then be filled into single serve cups or other containers and topped with additional de-aerated cocktail solution without calcium salt (i.e., storing solution). Several product fillers are capable of accomplishing this task, such as AllFill, Osgood, and Winpack. The finished product can then be collated, packed in cartons, and palletized for shipment using automated packaging methodology and equipment known in the art.

The foregoing description and the claims will be more readily understood by referring to the following non-limiting examples of the present invention, which are given to illustrate certain specific embodiments thereof rather than limit its scope. While the following non-limiting examples illustrate certain specific embodiments of the present invention, it will be apparent and manifest to, and envisioned by, persons of ordinary skill in the art reading this description that various modifications, rearrangements, changes, and variations may be made thereto without departing from the spirit and scope of the underlying present invention and that the same is not limited to the particular embodiments shown and described herein. In other words, the following examples are not intended to be exhaustive in scope, but rather are encompassed within the spirit and scope of the present invention and, thus, the present invention should not be construed as limited to the following embodiments.

### EXAMPLES

### Ingredient Sources

The juice used in the Lemon Drop formulation was Real Lemon brand lemon juice. Alternatively, the lemon juice can be purchased from Greenwood Associates, Inc., (6280 W. Howard Street Niles, IL 60714; (847) 579-5500; epeterson@greenwoodassociates.com).

The simple syrup used in the Lemon Drop formulation was prepared in the laboratory by dissolving granulated white sugar in distilled water in a ratio of 1:1 by volume. The simple syrup used in the Cosmopolitan, Electric Lemonade, Pineapple, and Sour Apple formulations was purchased from Domino Foods Inc., ((410) 783-9772; marc.colacicco@asr-group.com).

The clarified cranberry juice and pineapple juice concentrates were purchased from Greenwood Associates, Inc., (6280 W. Howard Street Niles, IL 60714; (847) 579-5500; epeterson@greenwoodassociates.com).

The calcium lactate gluconate was purchased from Modernist Pantry, (25 Harold Dow Highway, Eliot, ME 03903; (888) 578-3932; service@modernistpantry.com).

The malic and ascorbic acids were purchased from Parchem, (45 Huguenot Street, New Rochelle, NY 10801; (914) 654-6800; ml@parchem.com).

The Ticaxan Xanthan 200 powder and pre-hydrated Ticalose CMC 2500 powder was purchased from TIC Gums, (4609 Richlynn Dr., Belcamp, MD 21017; (410) 273-7300, ext. 3461; mparish@ticgums.com).

The cranberry (WONF MET0002774), lime (WONF MET0000056), lemon (MET0000324), orange (WONF MET0001773), pineapple (WONF MET0000066), apple (WONF MET0002150), and sour apple (MET0008868) flavors were purchased from FOODAROM, (5525 West 1730 South, Suite 202, Salt Lake City, UT 84104; (908) 752-1288; jblaney@foodarom.com).

The Magrabar MD-300 was purchased from Munzing North America, LP, (1455 Broad Street, 3rd Floor, Bloomfield, NJ 07003; (610) 469-4469; jwenger@munzing.us).

The FD&C Blue #1 and FD&C Yellow #5 powders were purchased from Prime, (280 N Midland Avenue, Saddle Brook, NJ 07663; (201) 414-3772; mike@primeingredients.com).

### General Procedure

Xanthan powder (e.g., Ticaxan Xanthan 200), anti-foam agent (e.g., Magrabar MD-300) and, if applicable, cellulose powder (e.g., Pre-Hydrated Ticalose CMC 2500) were combined to form a mixture. This mixture was then hydrated with distilled water for approximately 20 minutes or until a gel was formed and no free powder remained.

Alcoholic beverage (e.g., vodka, triple sec, etc.), simple syrup, fruit juice and/or clarified fruit juice concentrate, if applicable, and, optionally, distilled water were combined in a mixing container to form an alcoholic mixture. Calcium lactate gluconate and, if applicable, organic acid(s) (e.g., malic acid, ascorbic acid, etc.) were then dissolved into the alcoholic mixture with gentle agitation to aid dissolution. After dissolution of the calcium lactate gluconate and, if present, organic acids, any flavorants and/or colorants were then added to the alcoholic mixture.

The gel was added to the alcoholic mixture and mixed until fully dissolved and no solids are visible to form a cocktail solution. The cocktail solution was de-aerated until no trapped air bubbles remained (i.e., the solution was transparent).

A semi-sphere silicon mold was charged with 25 mL servings of the de-aerated cocktail solution. The charged mold was placed into a freezer having an interior temperature of -10° F. or lower for 5 to 6 hours to form frozen semi-spheres of the de-aerated cocktail solution.

A sodium alginate bath was prepared by dissolving sodium alginate powder in distilled water in a ratio by weight of 0.5% sodium alginate to 99.5% distilled water. The sodium alginate bath was allowed to rest for 3 to 4 hours until all trapped air bubbles dispersed and was allowed to equilibrate to room temperature before use.

The backs of the frozen molds were gently dipped into warm water for a few seconds and then the frozen semi-spheres were introduced into the sodium alginate bath. Immediately upon introduction of the frozen semi-spheres, the sodium alginate bath was gently agitated for 30 seconds to keep the semi-spheres constantly moving in the bath without touching each other. After this initial 30 seconds, the semi-spheres were gently swirled and flipped for the remainder of their time in bath to form spheres. After 10 minutes, the spheres were removed from the alginate bath and rinsed with distilled water. The spheres were then immersed in a storing solution, which is the same de-aerated cocktail solution from which they were made, minus the calcium lactate gluconate.

### Example 1 - Lemon Drop

Lemon Drop-flavored spheres according to the present invention were prepared according to the general procedure above using the following ingredients in the relative percentages by weight listed in Table 1:

TABLE 1

| Ingredients | Percentage (Weight%) |
|---|---|
| Vodka (80 Proof) | 33.62 |
| Lemon Juice | 26.90 |
| Distilled Water | 10.09 |
| Triple Sec (30 Proof) | 13.45 |
| Simple Syrup | 13.45 |
| Calcium Lactate Gluconate | 2.02 |
| Ticaxan Xanthan 200 Powder | 0.13 |
| Pre-Hydrated Ticalose CMC 2500 Powder | 0.13 |
| Magrabar MD-300 | 0.10 |
| Lemon Flavor MET00000324 | 0.10 |

The Ticaxan Xanthan 200 powder, pre-hydrated Ticalose CMC 2500 powder, and powdered anti-foam agent were combined and hydrated using all of the distilled water in accordance with the general procedure above to obtain the gel. The vodka, triple sec, lemon juice, simple syrup, calcium lactate gluconate, and lemon flavor were combined in accordance with the general procedure above to obtain the alcoholic mixture. No organic acids (e.g., malic and/or ascorbic acids) were used. The procedure yielded spheres according to the present invention with an inner core having a pH of 3.64, a Brix of 16 ± 1.0, an alcohol-by-volume (ABV) of 17%, and a shelf life of 1 month.

### Example 2 - Cosmopolitan

Cosmopolitan-flavored spheres according to the present invention were prepared according to the general procedure above using the following ingredients in the relative percentages by weight listed in Table 2:

TABLE 2

| Ingredient | Percentage (Weight%) |
|---|---|
| Distilled Water | 40.46 |
| Vodka (80 proof) | 38.72 |
| Simple Syrup | 14.69 |
| Cranberry Juice Concentrate Clarified | 2.93 |
| Calcium Lactate Gluconate | 2.00 |
| Malic Acid | 0.33 |
| Ascorbic Acid | 0.27 |
| Ticaxan Xanthan 200 Powder | 0.20 |
| Cranberry Flavor WONF MET0002774 | 0.20 |
| Lime Flavor WONF MET0000056 | 0.10 |
| Magrabar MD-300 | 0.10 |

The Ticaxan Xanthan 200 powder and Magrabar MD-300 were combined and hydrated using approximately one third of the distilled water in accordance with the general procedure above to obtain the gel. The vodka, simple syrup, clarified cranberry juice concentrate, calcium lactate gluconate, malic and ascorbic acids, cranberry and lime flavors, and the remaining distilled water were combined in accordance with the general procedure above to obtain the alcoholic mixture. The procedure yielded spheres according to the present invention with an inner core having a pH of from 3.8 to 2.8, a Brix of 16.6 ± 1.0, an alcohol-by-volume (ABV) of 17%, and a shelf life of 12 months. The spheres were stored in a Cosmopolitan storing solution (i.e., all Cosmopolitan inner core components minus the calcium lactate gluconate) having a pH in the range of from 2.708 to 2.578, a Brix of 14.8 ± 1.0, and an alcohol-by-volume (ABV) of 17%.

### Example 3 - Electric Lemonade

Electric Lemonade-flavored spheres according to the present invention were prepared according to the general procedure above using the following ingredients in the relative percentages by weight listed in Table 3:

TABLE 3

| Ingredients | Percentage (Weight%) |
|---|---|
| Distilled Water | 40.65 |
| Vodka (80 proof) | 39.73 |
| Simple Syrup | 15.94 |
| Calcium Lactate Gluconate | 2.02 |
| Malic Acid | 0.68 |
| Ascorbic Acid | 0.45 |
| Ticaxan Xanthan 200 Powder | 0.20 |
| Lemon Flavor MET0000324 | 0.17 |
| Magrabar MD-300 | 0.12 |
| Orange Flavor WONF MET0001773 | 0.07 |
| FD&C Blue #1 Powder | 0.001 |

The Ticaxan Xanthan 200 powder and Magrabar MD-300 were combined and hydrated using approximately one third of the distilled water in accordance with the general procedure above to obtain the gel. The vodka, simple syrup, calcium lactate gluconate, malic and ascorbic acids, lemon and orange flavors, FD&C Blue #1 powder, and the remaining distilled water were combined in accordance with the general procedure above to obtain the alcoholic mixture. The procedure yielded spheres according to the present invention with an inner core having a pH of from 3.7 to 3.8, a Brix of 16.4 ± 1.0, an alcohol-by-volume (ABV) of 18%, and a shelf life of 12 months. The spheres were stored in an Electric Lemonade storing solution (i.e., all Electric Lemonade inner core components minus the calcium lactate gluconate) having a pH in the range of from 2.598 to 2.648, a Brix of 19.2 ± 1.0, and an alcohol-by-volume (ABV) of 18%.

### Example 4 - Pineapple Crush

Pineapple Crush-flavored spheres according to the present invention were prepared according to the general procedure above using the following ingredients in the relative percentages by weight listed in Table 4:

TABLE 4

| Ingredients | Percentage (Weight%) |
|---|---|
| Vodka (80 proof) | 40.81 |
| Distilled Water | 37.63 |
| Simple Syrup | 13.80 |
| Pineapple Juice Concentrate Clarified | 4.33 |
| Calcium Lactate Gluconate | 2.07 |
| Ascorbic Acid | 0.59 |
| Malic Acid | 0.34 |
| Pineapple Flavor WONF MET0000066 | 0.28 |
| Ticaxan Xanthan 200 Powder | 0.10 |
| Magrabar MD-300 | 0.05 |
| FD&C Yellow #5 Powder | 0.0004 |

The Ticaxan Xanthan 200 powder and Magrabar MD-300 were combined and hydrated using approximately one third of the distilled water in accordance with the general procedure above to obtain the gel. The vodka, simple syrup, clarified pineapple juice concentrate, calcium lactate gluconate, malic and ascorbic acids, pineapple flavor, FD&C Yellow #5 powder, and the remaining distilled water were combined in accordance with the general procedure above to obtain the alcoholic mixture. The procedure yielded spheres according to the present invention with an inner core having a pH of from 3.9 to 4.0, a Brix of 18 ± 1.0, an alcohol-by-volume (ABV) of 18%, and a shelf life of 12 months. The spheres were stored in a Pineapple Crush storing solution (i.e., all Pineapple Crush inner core components minus the calcium lactate gluconate) having a pH in the range of from 3.061 to 3.111, a Brix of 17.4 ± 1.0, and an alcohol-by-volume (ABV) of 18%.

### Example 5 - Sour Apple

Sour Apple-flavored spheres according to the present invention were prepared according to the general procedure above using the following ingredients in the relative percentages by weight listed in Table 5:

TABLE 5

| Ingredients | Percentage (Weight%) |
|---|---|
| Distilled Water | 41.54 |
| Vodka (80 proof) | 40.81 |
| Simple Syrup | 14.26 |
| Calcium Lactate Gluconate | 2.00 |
| Malic Acid | 0.47 |
| Ascorbic Acid | 0.36 |
| Apple Flavor WONF MET0002150 | 0.20 |
| Ticaxan Xanthan 200 Powder | 0.15 |
| Sour Apple Flavor WONF MET0008868 | 0.12 |
| Magrabar MD-300 | 0.10 |
| FD&C Yellow #5 Powder | 0.00015 |
| FD&C Blue #1 Powder | 0.00004 |

The Ticaxan Xanthan 200 powder and Magrabar MD-300 were combined and hydrated using approximately one third of the distilled water in accordance with the general procedure above to obtain the gel. The vodka, simple syrup, calcium lactate gluconate, malic and ascorbic acids, apple and sour apple flavors, FD&C Yellow #5 and Blue #1 powders, and the remaining distilled water were combined in accordance with the general procedure above to obtain the alcoholic mixture. The procedure yielded spheres according to the present invention with an inner core having a pH in the range of from 3.87 to 3.92, a Brix of 16 ± 1.0, an alcohol-by-volume (ABV) of 18%, and a shelf life of 12 months. The spheres were stored in a Sour Apple storing solution (i.e., all Sour Apple inner core components minus the calcium lactate gluconate) having a pH in the range of from 2.622 to 2.672, a Brix of 16 ± 1.0, and an alcohol-by-volume (ABV) of 18%.

1. A shelf stable, edible sphere comprising (1) a liquid and/or gel inner core comprising ethyl alcohol and (2) an outer membrane comprising alginate, wherein the outer membrane coats and encapsulates the liquid and/or gel inner core and wherein the shelf stable, edible sphere is shelf stable for at least one month.

2. The shelf stable, edible sphere of claim 1, wherein the ethyl alcohol is derived from an alcoholic beverage.

3. The shelf stable, edible sphere of claim 2, wherein the alcoholic beverage is derived from a distilled spirit and/or a liqueur.

4. The shelf stable, edible sphere of claim 3, wherein the distilled spirit is selected from the group consisting of grain alcohol, vodka, gin, rum, tequila, whiskey/whisky, brandy, cachaça, metaxa, mezcal, ouzo, absinthe, and any combination thereof.

5. The shelf stable, edible sphere of claim 1, wherein the outer membrane further comprises an edible coating and encapsulating material in addition to the alginate.

6. The shelf stable, edible sphere of claim 1, wherein the outer membrane further comprises one or more components selected from the group consisting of sweeteners, stabilizers, preservatives, flavorants, colorants, and any combination thereof.

7. The shelf stable, edible sphere of claim 1, wherein the liquid and/or gel inner core comprises one or more components selected from the group consisting of water, an organic acid, a calcium salt, a fruit juice, a fruit juice concentrate, a sweetener, a stabilizer, a preservative, a thickener, an anti-foaming agent, a natural flavorant, an artificial flavorant, a colorant, and any combination thereof.

8. The shelf stable, edible sphere of claim 7, wherein the organic acid is selected from the group consisting of ascorbic acid, malic acid, and any combination thereof.

9. The shelf stable, edible sphere of claim 7, wherein the calcium salt is selected from the group consisting of calcium lactate, calcium lactate gluconate, and any combination thereof.

10. The shelf stable, edible sphere of claim 7, wherein the stabilizer and/or the thickener is selected from the group consisting of xanthan-based gums, cellulose-based gums, and any combination thereof.

11. The shelf stable, edible sphere of claim 7, wherein the fruit juice and/or the fruit juice concentrate is selected from the group consisting of lemon juice, clarified cranberry juice concentrate, clarified pineapple juice concentrate, and any combination thereof.

12. The shelf stable, edible sphere of claim 7, wherein the natural flavorant and/or the artificial flavorant is selected from the group consisting of lemon flavorants, lime flavorants, cranberry flavorants, lime flavorants, orange flavorants, pineapple flavorants, apple flavorants, sour apple flavorants, peach flavorants, and any combination thereof.

13. (canceled)

14. The shelf stable, edible sphere of claim 1, wherein the thickness of the outer membrane is in the range of from 0.01 mm to 0.5 mm.

15. (canceled)

16. (canceled)

17. (canceled)

18. (canceled)

19. The shelf stable, edible sphere of claim 1, wherein the shelf stable, edible sphere is shelf stable for at least 12 months.

20. A process for preparing a shelf stable, edible sphere, comprising
(1) combining an alcoholic beverage, a calcium salt, and optionally one or more further components selected from the group consisting of a stabilizer, a thickener, an anti-foaming agent, an organic acid, a sweetener, a fruit juice, a fruit juice concentrate, water, a natural flavorant, an artificial flavorant, a colorants, and a preservative, and any combination thereof, to form a cocktail solution;
(2) de-aerating the cocktail solution to form a de-aerated cocktail solution;
(3) freezing the de-aerated cocktail solution to form a frozen cocktail solution or adding a thickening compound to the de-aerated cocktail solution to form a viscous cocktail solution;
(4) immersing the frozen or viscous cocktail solution in a sodium alginate bath at ambient temperature or at a controlled temperature above or below ambient temperature for a period of time to form an edible sphere; and
(5) removing the edible sphere from the alginate bath and rinsing the edible sphere with water to form a shelf stable, edible sphere.

21. The process of claim 20, wherein the stabilizers, thickeners, and/or anti-foaming agents are hydrated prior to combination with the alcoholic beverage and the calcium salt.

22. The process of claim 20, wherein the de-aerated cocktail solution is frozen in a semispherical mold.

23. The process of claim 20, wherein the de-aerated cocktail solution is frozen at a temperature of -10° F. or lower.

24. The process of claim 20, wherein the sodium alginate bath is prepared by dissolving sodium alginate powder in distilled water in a ratio by weight of 0.5% sodium alginate to 99.5% distilled water.

25. The process of claim 20, wherein the frozen cocktail solution is immersed in the sodium alginate bath at ambient temperature for at least 10 minutes.
